(19) United States
(12) Patent Application Publication
(10) Pub. No.: US 2004/0022615 A1
(43) Pub. Date: Feb. 5, 2004

(54) Compressor lift

(76) Inventor: Richard K. Land, Logansport, LA (US)

Correspondence Address: John M. Harrison, 2139 E. Bert Kouns, Shreveport, LA, 71105, US

(21) Appl. No.: 10/341,019

(22) Filed: Jan. 14, 2003

Related U.S. Application Data
(60) Provisional application No. 60/361,377, filed on Mar. 4, 2002.

(51) Int. Cl. B66F 1/00

(52) U.S. Cl. 414/630

(57) ABSTRACT

A compressor lift for lifting compressors from air conditioning enclosures and replacing the compressors in the enclosures, which lift is characterized in a preferred embodiment by a telescoping mast mounted on a wheeled dolly fitted with pivoting and hinged outriggers for stability. The winch housing of a winch is attached to the top of the mast with a 360° degree rotation and a cable extends from a worm and spur gear-operated drum in a winch housing for selectively winding on the drum and extending from the drum responsive to operation of the worm gear, to raise and lower the compressor. The worm gear drive is typically operated by a hand crank or an electric drill to selectively extend and retract the cable and raise and lower the compressors.

### CROSS-REFERENCE TO RELATED APPLICATIONS

This application claims the benefit of prior filed U.S. copending Provisional Application Serial No. 60/361,377, filed Mar. 4, 2002.

### BACKGROUND OF THE INVENTION

### Field of the Invention

This invention relates to equipment for removing and replacing compressors from and into compressor housings and more particularly, to a new and improved compressor lift for engaging a lift handle attached to a compressor and raising and lowering the compressor with respect to the compressor housing by means of a winch. In a preferred embodiment the compressor lift includes an extensible, typically telescoping mast, the lower segment of which is mounted on a wheeled dolly having pivotable and hinged, telescoping outriggers for stability; a worm and spur gear-operated winch provided at the top of the mast; and a cable extensible from and retractable onto a drum on the spur gear for attachment to the compressor lift handle and raising and lowering a compressor from and to the compressor housing. The winch is rotatably mounted on the telescoping mast and the worm gear and spur gear combination are driven to raise and lower the cable and the compressor by operation of an electric drill or a hand crank.

One of the problems which exists in lifting compressors from compressor enclosures and replacing these compressors after repair or during replacement is the weight and location of the compressors. These compressors are typically bolted inside a compressor housing with limited access and are typically fitted with a compressor lift handle and lifted by the workman without the use of mechanical devices to aid in the lifting process. Occasionally, the workman will rig an A-frame and “comealong” device to raise and lower the compressor by hand-operation of the “comealong”, but these devices are make-shift at best and are ineffective to quickly, adequately, efficiently and safely raise and lower the compressor in a short period of time. Accordingly, there exists a need in the art for a winch mechanism that can be quickly, easily, efficiently and safely deployed at the compressor site to raise and lower a compressor from and into a compressor housing without undo exertion on the part of the repairman and in a short period of time.

Accordingly, it is an object of this invention to provide a new and improved compressor lift which is characterized by a winch mounted on an adjustable, typically telescoping mast, which mast is attached to a wheeled dolly for carrying the compressor to and from the compressor site and raising and lowering the compressor with respect to the compressor housing for repair or replacement.

Another object of the invention is to provide a new and improved compressor lift apparatus designed to raise and lower a compressor from and into a compressor housing utilizing a worm gear and spur gear-driven winch cable and winch system mounted on a vertically-extensible mast attached to a wheeled dolly having pivoting and hinged outriggers for securing the dolly in a stable position adjacent to the compressor housing during the compressor raising and lowering process.

Another object of the invention is to provide a new and improved compressor lift and wheeled-dolly combination, which lift is designed to raise and lower a compressor from and into a compressor housing using a telescoping mast and a winch having a winch cable operated by a worm and spur gear system that can be driven by an electric drill or a hand crank to raise and lower the compressor at will.

Still another object of this invention is to provide a new and improved compressor lift apparatus which includes a vertical, telescoping mast system mounted on a wheeled dolly having pivoting and hinged outriggers for stabilizing the wheeled dolly on a supporting surface near a compressor housing. The mast is fitted with a 360°-degree rotatable winch system that includes a winch cable wound on a spur gear drum driven by a worm gear, which worm gear is operated by an electric drill or a hand crank to raise and lower the compressor when the compressor is attached to the winch cable.

### SUMMARY OF THE INVENTION

These and other objects of the invention are provided in a new and improved compressor lift fitted to a wheeled dolly, which dolly is operable to carry a compressor to and from a truck or a work station. The compressor lift is characterized by an extensible and retractable, typically telescoping mast attached to the dolly and provided with a 360°-degree horizontally rotatable winch at the top, which winch includes a drum-mounted spur gear engaging a worm gear driven by an electric drill or a hand crank. A winch cable is wound on the drum attached to the spur gear and is fitted with a cable sleeve for engaging a lift handle attached to a compressor, for raising and lowering the compressor with respect to a compressor housing upon operation of the worm gear by the electric drill or the hand crank. A pair of telescoping outriggers are pivotally and hingedly attached to the wheeled dolly to facilitate extension thereof and stabilizing the wheeled dolly on a supporting surface and/or against a wall, under circumstances where the winch is used to lift or lower the compressor from or to the compressor housing using the winch cable.

The invention will be better understood by reference to the accompanying drawings wherein:

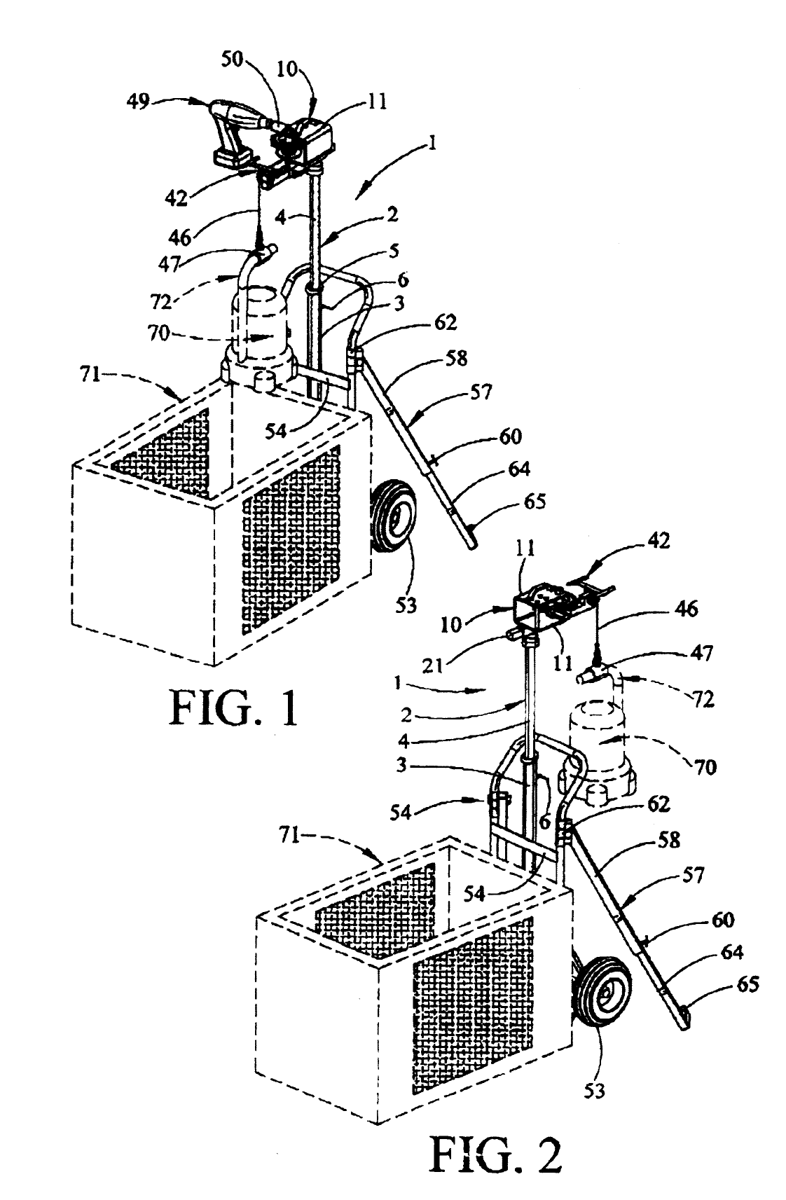

FIG. 1 is a perspective view of a preferred embodiment of the compressor lift of this invention located in close proximity to a compressor housing and illustrating lifting a compressor from the compressor housing by operation of an electric drill;

FIG. 2 is a perspective view of the compressor lift illustrated in FIG. 1, more particularly illustrating operation of the rotating winch component of the compressor lift to facilitate 180° degree rotation of the compressor and lowering of the compressor to the ground after removal from the compressor housing;

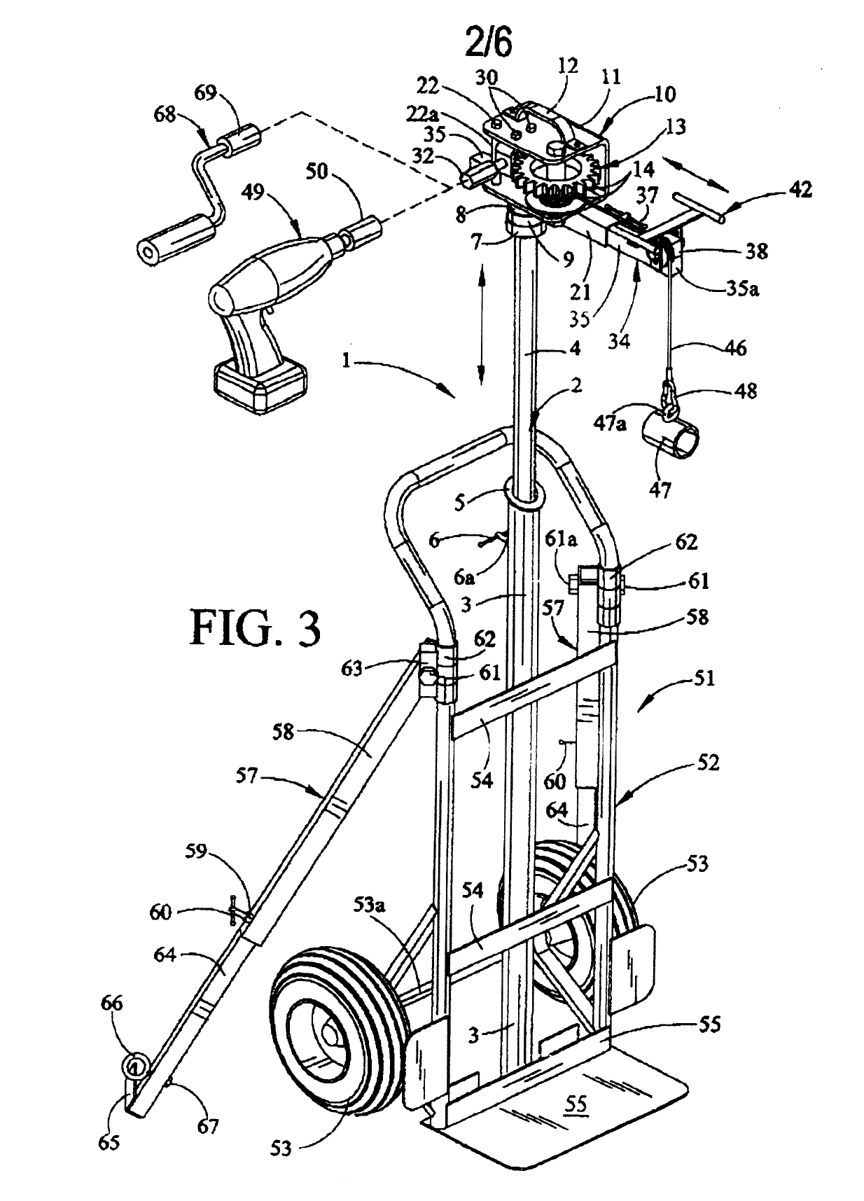

FIG. 3 is a perspective view of the compressor lift illustrated in FIGS. 1 and 2, more particularly illustrating alternative electric drill and hand crank drives and a preferred telescoping mast winch and outrigger system for use in cooperation with a wheeled dolly to stabilize the compressor under load as it is lifted to and from a compressor housing;

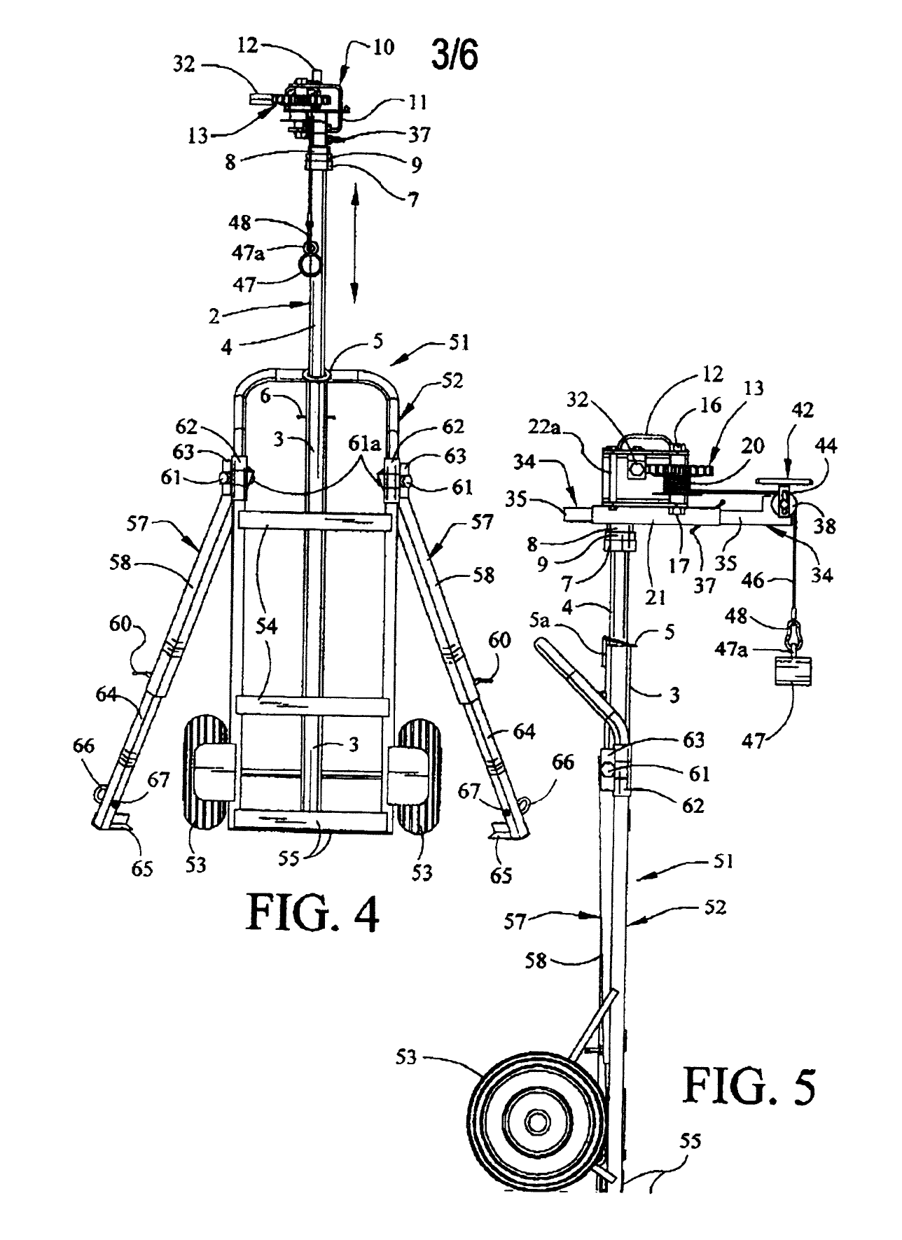

FIG. 4 is a rear view of the compressor lift illustrated in FIGS. 1-3 with the outriggers pivotally and hingedly extended and deployed in functional configuration;

FIG. 5 is a left side view of the compressor lift illustrated in FIG. 4 with the outriggers in retracted, non-deployed configuration;

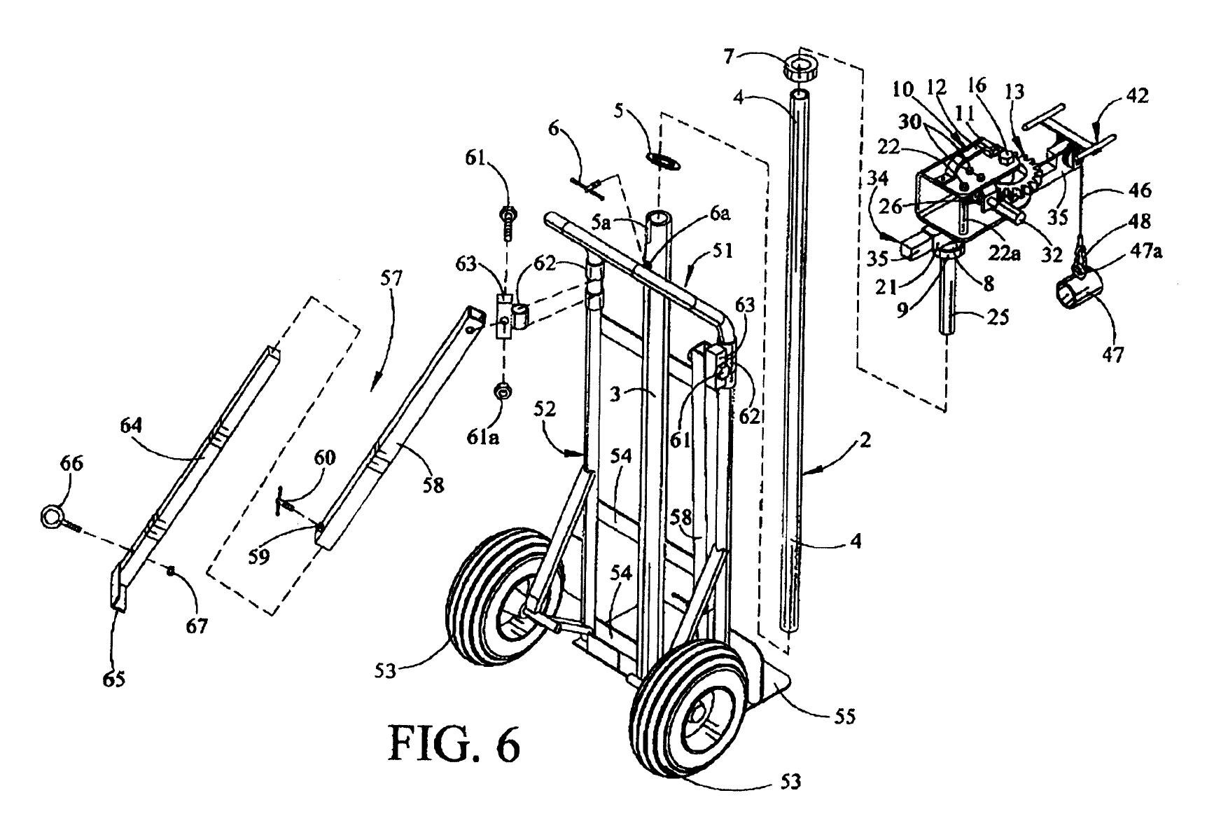

FIG. 6 is an exploded view of a preferred winch system and outrigger arrangement used in cooperation with a wheeled dolly element of the compressor lift of this invention;

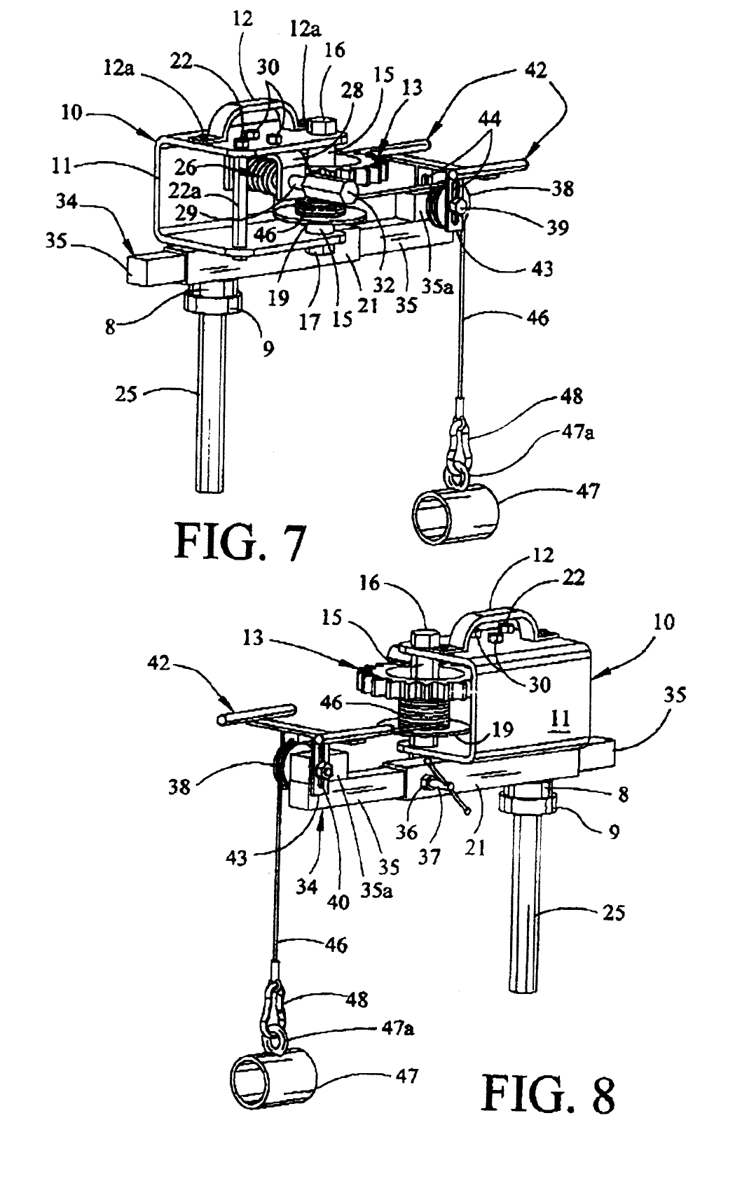

FIG. 7 is a rear perspective view of a preferred winch element of the compressor lift of this invention;

FIG. 8 is a front perspective view of the compressor lift winch element illustrated in FIG. 7;

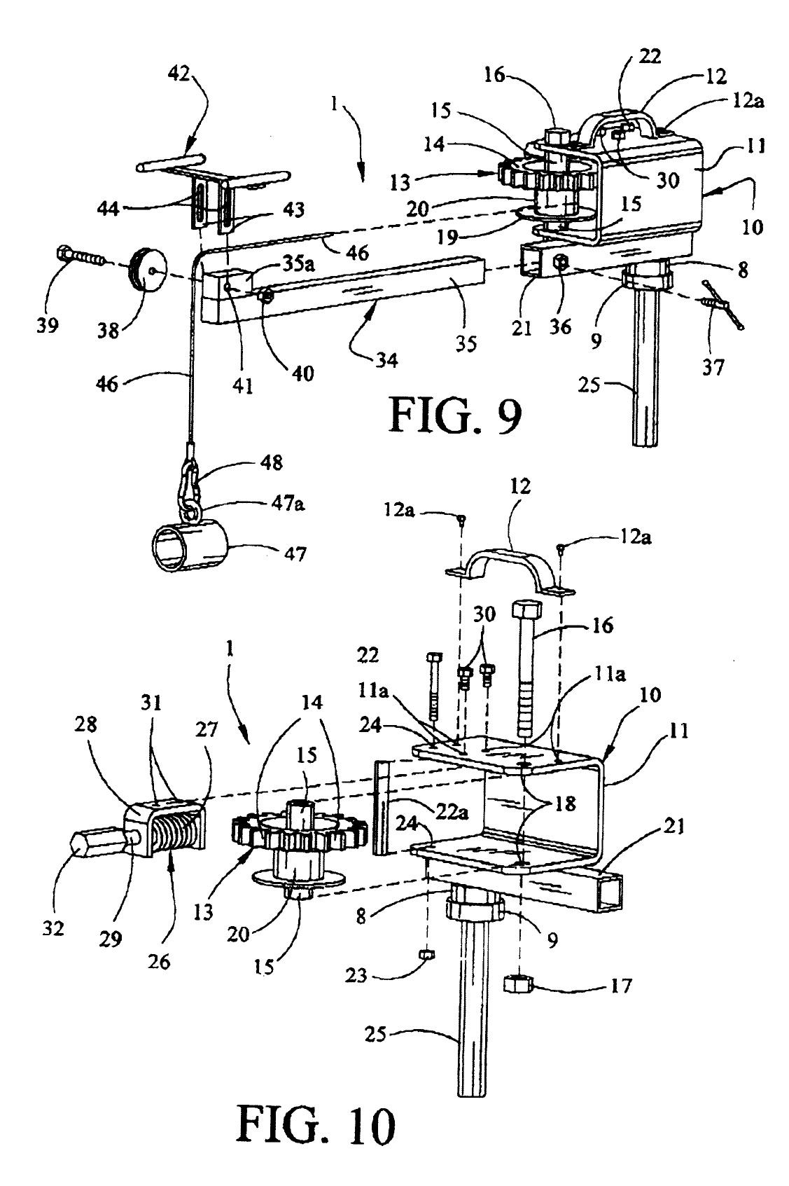

FIG. 9 is an exploded view of boom and slide pulley elements and spur gear and winch cable drum components of the compressor lift winch illustrated in FIG. 8; and

FIG. 10 is an exploded view of the worm gear and spur gear drive components of the compressor lift winch illustrated in FIGS. 8 and 9.

### DESCRIPTION OF THE PREFERRED EMBODIMENTS

Referring initially to FIGS. 1-6 of the drawings, the compressor lift of this invention is generally illustrated by reference numeral 1. The compressor lift 1 is characterized by a mast 2, which includes a mast base 3 mounted on a pair of cross-braces 54 in a dolly 51 and having a mast extension 4 telescopically mounted in the mast base 3 to facilitate raising and lowering a winch 10, attached to the top of the mast extension 4. An extension set ring 5 is fitted on the mast extension 4 at the point where the mast extension 4 telescopes into the mast 2 and a set ring key 5a (illustrated in FIG. 6) serves to maintain the extension set ring 5 in a canted orientation at an angle with respect to the horizontal to facilitate raising and lowering the mast extension 4 to a selected height in the mast base 3 and maintaining the mast extension 4 in that position by engagement with the canted extension set ring 5. A mast extension set screw 6 is threadably seated in an extension nut 6a provided on the mast extension 4 as illustrated in FIG. 3, to facilitate a locked position of the mast extension 4 with respect to the mast base 3.

In a preferred embodiment of the invention the mast base 3 extends upwardly from attachment to the parallel cross braces 54, mounted on the dolly frame 52 of a dolly 51 having dolly wheels 53 mounted on a wheel axle 53a, as more particularly illustrated in FIGS. 3-6. As further illustrated in FIGS. 1-6, two outriggers 57 are mounted in spaced-apart relationship with respect to each other to the dolly frame 52 of the dolly 51. Specifically, a top outrigger member 57 is attached to the dolly frame 52 by means of an outrigger mount hinge 62 and a corresponding mount hinge flange 63, the latter of which is secured to the top outrigger member 58 by means of a top outrigger mount bolt 61 and a nut 61a. Accordingly, it will be appreciated from a consideration of FIG. 3 of the drawings that each top outrigger member 58 may be pivoted on the corresponding top outrigger mount bolt 61, extending through each mount hinge flange 63, respectively, and is also rotatable with respect to the dolly frame 52 by operation of the outrigger mount hinge 62. A telescoping outrigger member 64 telescopes into each of the respective top outrigger members 58 and each of the telescoping outrigger members 64 is secured in a selected extended and retracted configuration by means of an outrigger lock pin 60, threadably inserted in a corresponding top outrigger lock nut 59 and extending through the top outrigger members 58 to engage the corresponding telescoping outrigger member 64, upon tightening of an outrigger lock pin 60. A foot 65 is welded or otherwise attached to the extending end of the telescoping outrigger member 64 for engagement with a supporting surface (not illustrated) and a foot ring 66 is also secured to the telescoping outrigger member 64, typically above the foot 65 by means of a foot ring nut 67. Accordingly, it will be appreciated from a consideration of FIGS. 4 and 5 of the drawings that the outriggers 57, including the top outrigger member 58 and the telescoping outrigger member 64 in each pair, can be essentially universally pivotally and hingedly positioned as illustrated in FIG. 5, for storage purposes or pivoted outwardly and extended downwardly, against a supporting surface, typically as illustrated in FIG. 4 to stabilize the dolly 51 in close proximity to the compressor housing 71, illustrated in phantom in FIGS. 1 and 2. When positioned in the configuration illustrated in FIGS. 1 and 2, the compressor lift 1 can be operated to lift a compressor 70 using a compressor lift handle 72, also illustrated in phantom, as hereinafter described.

Referring now to FIGS. 6-10 of the drawings, the winch 10 is designed to rotatably and removably fit on the top of the mast extension 4 of the mast 2 by means of a winch mount shaft 25, extending downwardly from the winch 10, as illustrated. Accordingly, as further illustrated in FIG. 6, the winch mount shaft 25 is designed to seat inside the top end of the mast extension 4 on a pivot bearing 9 which is sandwiched between a winch collar 8, attached to the housing mount tubing 21 of the gear housing 11, and an extension pivot collar 7, secured to the top end of the mast extension 4. The pivot bearing 9 facilitates 360° degree rotatable movement in a horizontal plane of the entire winch 10 with respect to the mast extension 4 to swing the compressor from the position illustrated in FIG. 1 to the position illustrated in FIG. 2, as hereinafter further described.

As further illustrated in FIGS. 6-10, the gear housing 11 is characterized by spaced-apart housing bolt openings 11a and a pair of vertically aligned brace bolt openings 24, as detailed in FIG. 10, the latter positioned for receiving a housing brace bolt 22, extending through a spacer 22a and secured by a brace bolt nut 23 for stabilizing the generally U-shaped gear housing 11. Furthermore, worm gear mount bolts 30 extend through two of the housing bolt openings 11a and thread into the corresponding worm gear mount bolt openings 31, tapped in the worm gear frame 28 of a worm gear 26, having worm gear teeth 27 and fitted with a worm gear shaft 29. A worm gear adaptor 32 is typically fitted to the worm gear shaft 29 for engagement and driving by either an electric drill 49, having an adaptor drive 50, or a hand crank 68, fitted with a hand crank adaptor 69 (FIG. 3), both the adaptor drive 50 and the hand crank adaptor 69 being designed to engage the worm gear adaptor 32 and drive the worm gear 26, as hereinafter described. A handle 12 is typically provided on the gear housing 11 and is attached thereto by means of handle bolts 12a which thread into additional housing bolt openings 11a, as further illustrated in FIG. 10. A spur gear 13, provided with spur gear teeth 14, is fitted with a spur gear shaft 15 and a cable drum 20, for rotatable disposition in the gear housing 11 by means of a spur gear mount bolt 16, which extends through corresponding, vertically aligned mount bolt openings 18 and is secured in place by means of a mount bolt nut 17. A cable ring 19 is secured to the cable drum 20 in spaced-apart relationship with respect to the spur gear 13, to facilitate winding of a cable 46 on the cable drum 20 between the spur gear 13 and cable ring 19, as illustrated in FIGS. 7 and 8.

As further illustrated in FIGS. 7-10, the housing mount tubing 21 of a boom 34 is mounted on the bottom of the gear housing 11 by welding or other suitable means and includes a boom slide 35, typically telescopically mounted in the boom 34 and having an enlarged pulley mount end 35a in the extending end thereof. As illustrated in FIG. 9, a slide nut 36 is provided in the housing mount tubing 21 for receiving a slide lock pin 37 and selectively locking the boom slide 35 at a selected extension with respect to the housing mount tubing 21. A slide pulley 38 is mounted on the pulley mount end 35a of the boom slide 35 by means of a slide pulley shaft 39, which extends through a pulley shaft opening 41 in the pulley mount end 35a. A pulley shaft nut 40 secures a slide pulley shaft 39 in place and the slide pulley 38 rotatably in position on the pulley mount end 35a of the boom slide 35. The slide pulley 38 is positioned between a pair of spaced-apart cable guide legs 43, that extend downwardly in a cable guide 42, which cable guide legs 43 are provided with vertical, spaced-apart and aligned leg slots 44 for also receiving the slide pulley shaft 39, as further illustrated in FIG. 9. The cable 46 is wound on the cable drum 20 as illustrated in FIGS. 7 and 8 and extends between the cable guide legs 43, over the slide pulley 38 and downwardly to terminate at a sleeve connector 48 that engages the sleeve ring 47a of a cable sleeve 47. The cable sleeve 47 is designed to removably slide onto the horizontal leg of the L-shaped compressor lift handle 72, illustrated in phantom in FIGS. 1 and 2.

In operation, and referring again to FIGS. 1-5 of the drawings, under circumstances where it is desired to lift an unbolted compressor 70 from the interior of a compressor housing 71, the dolly 51 is configured as illustrated in FIG. 5 and is first rolled into close proximity to the compressor housing 71 with the dolly wheels 53 typically located adjacent the compressor housing 71, as illustrated in FIG. 1. The outriggers 57 are then deployed as illustrated in FIGS. 1 and 4 by initially pivoting the top outrigger members 58 on the outrigger mount hinges 62 and the mount hinge flanges 63 as illustrated in FIG. 3, to the position illustrated in FIG. 3. Each of the outrigger lock pins 60 is then loosened to facilitate extension of the respective telescoping outrigger members 64 from the corresponding top outrigger members 58 to a supporting surface (not illustrated) and the outrigger lock pins 60 are then again tightened to secure the respective outriggers 57 in outwardly-extended configuration as illustrated in FIG. 4 of the drawings. The winch 10 is then lifted with the mast extension 4 by loosening the extension set screw 6 (FIG. 3) and manipulating the extension set ring 5 to facilitate extension of the mast extension 4 from the mast base 3 to a desired height above the compressor housing 71, as illustrated in FIG. 1. When the desired elevated position of the winch 10 is reached, the extension set ring is again manipulated against the set ring key 5a and the mast extension 4 to secure the mast extension 4 in the elevated position illustrated in FIG. 1. Further security in positioning of the mast extension 4 at the desired height may be achieved by tightening the extension set screw 6. An electric drill 49, which is typically cordless in design, or a hand crank 68 (FIGS. 1 and 3) is then positioned adjacent the winch 10, and the adaptor drive 50 attached to the electric drill 50, or the hand crank adaptor 69 is seated on the corresponding worm gear adaptor 32 as further illustrated in FIG. 3. The electric drill 49 or hand crank 68 is then operated to lower the cable 46 and the corresponding cable sleeve 47 downwardly to the point where it may be slipped onto the horizontal component of the compressor lift handle 72, previously attached to the compressor 70 in conventional fashion. Operation of the electric drill 49 or hand crank 68 is then reversed and the winch is operated in reverse to drive the worm gear 26 and the corresponding spur gear 13, wind the cable 46 on the cable drum 20, and raise the compressor 70 to the position illustrated in FIG. 1. When the compressor 70 is above the top of the compressor housing 71 as illustrated in FIG. 1, the winch 10 is manually rotated on the pivot bearing 9, sandwiched between the extension pivot collar 7 and the winch collar 8, to swing the compressor 7 to a position approximately 180° degrees located from the position illustrated in FIG. 1. The electric drill 49 or hand crank 68 can then be again reversed in operation to lower the compressor 70 and position it on a workbench or on the cargo plate 55 of the dolly 51, for transportation to a truck or to a specified location for repair or replacement.

It will be appreciated by those skilled in the art that the compressor lift of this invention facilitates a quick and easy way of removing and replacing compressors in air conditioning units in a safe and effective manner, utilizing a wheeled-mounted dolly fitted with adjustable outriggers for stability. It will be further appreciated from a consideration of FIGS. 1 and 2 that the outriggers 57 serve to maintain the heavy compressor 70 in a stable configuration regardless of the relative position of the winch 10 and the compressor 70 as the compressor is moved from the position illustrated in FIG. 1 to the position illustrated in FIG. 2, or to any alternative position in a 360° degree orientation. Furthermore, when the lifting operation is complete, the outriggers 57 can be quickly and easily repositioned to the configuration illustrated in FIG. 5 with the respective telescoping outrigger members 64 extended into the corresponding top outrigger members 58 and secured by means of the respective outrigger lock pins 60, as described above. Moreover, it will be appreciated by those skilled in the art that the winch 10 can be removed from the mast extension 4 simply by lifting it upwardly as the winch mount shaft 25 illustrated in FIG. 6 is easily removed from the interior of the top end of the mast extension 4. Under these circumstances the extension pivot collar 7 remains in place, fixed to the mast extension 4 while the winch collar 8, which is welded or otherwise attached to the gear housing 11 and the pivot bearing 9 are removed with the winch 10, as further illustrated in FIG. 6. Accordingly, the winch 10 can be stored separately from the remaining elements of the compressor lift 1 and the dolly 51 then used in conventional fashion to transport various cargo, with the outriggers 57 folded in position as illustrated in FIG. 5.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A compressor lift comprising a wheeled dolly; a mast carried by said dolly; and a winch mounted on said mast for engaging and lifting a compressor.

2. The compressor lift of claim 1 comprising a pair of outriggers pivotally carried by said dolly for extension from said dolly and contacting a supporting surface and stabilizing said winch and the compressor.

3. The compressor of claim 1 wherein said mast is characterized by a mast base attached to said wheeled dolly, a mast extension adjustably extendible from said mast base and mast adjusting means engaging said mast base and said mast extension for selectively securing said mast extension in a selected position with respect to said mast base.

4. The compressor of claim 3 comprising a pair of outriggers pivotally carried by said dolly for extension from said dolly and contacting a supporting surface and stabilizing said winch and the compressor.

5. The compressor lift of claim 1 wherein said winch is characterized by a housing rotatably carried by said mast; a spur gear journaled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

6. The compressor lift of claim 5 comprising a pair of outriggers pivotally carried by said dolly for extension from said dolly and contacting a supporting surface and stabilizing said winch and the compressor.

7. The compressor lift of claim 5 wherein said mast is characterized by a mast base attached to said wheeled dolly, a mast extension adjustably extendible from said mast base and mast adjusting means engaging said mast base and said mast extension for selectively securing said mast extension with respect to said mast base.

8. The compressor lift of claim 7 comprising a pair of outriggers pivotally carried by said dolly for extension from said dolly and contacting a supporting surface and stabilizing said winch and the compressor.

9. A lifting device for raising and lowering a compressor with respect to a compressor housing, comprising a wheeled dolly; an extensible mast mounted on said dolly; a winch rotatably carried by said mast; and a pair of outriggers pivotally carried by said dolly for extension from said dolly and contacting a supporting surface and stabilizing said winch and the compressor.

10. The lifting device of claim 9 wherein said mast is characterized by a mast base attached to said wheeled dolly, a mast extension adjustably extendible from said mast base and mast adjusting means engaging said mast base and said mast extension for selectively securing said mast extension with respect to said mast base.

11. The lifting device of claim 9 wherein said winch is characterized by a housing rotatably carried by said mast; a spur gear journaled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

12. The lifting device of claim 9 wherein:
(a) said mast is characterized by a mast base attached to said wheeled dolly, a mast extension adjustably extendible from said mast base and mast adjusting means engaging said mast base and said mast extension for selectively securing said mast extension with respect to said mast base; and
(b) said winch is characterized by a housing rotatably carried by said mast extension; a spur gear journaled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

13. The lifting device of claim 9 wherein said outriggers are each characterized by a top outrigger member pivotally and hingedly connected to said dolly, a bottom outrigger member extendible from said top outrigger member to a selected position and outrigger adjusting means engaging said top outrigger member and said bottom outrigger member for selectively securing said bottom outrigger member with respect to said top outrigger member in said selected position.

14. The lifting device of claim 13 wherein said mast is characterized by a mast base attached to said wheeled dolly, a mast extension adjustably extendible from said mast base and mast adjusting means engaging said mast base and said mast extension for selectively securing said mast extension with respect to said mast base.

15. The lifting device of claim 13 wherein said winch is characterized by a housing rotatably carried by said mast; a spur gear joumrnled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

16. The lifting device of claim 13 wherein:
(a) said mast is characterized by a mast base attached to said wheeled dolly, a mast extension selectively extendible from said mast base and mast adjusting means engaging said mast base and said mast extension for selectively securing said mast extension with respect to said mast base; and
(b) said winch is characterized by a housing rotatably carried by said mast extension; a spur gear journaled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

17. A lifting device for raising and lowering a compressor with respect to a compressor housing, comprising a wheeled dolly; a telescoping mast mounted on said dolly; a winch housing rotatably carried by said mast; a spur gear journaled for rotation in said housing; a cable drum provided on said spur gear and a cable wound on said cable drum, with one end of said cable attached to said cable drum and the opposite end of said cable adapted for removably engaging the compressor; a worm gear journaled for driving rotation in said housing, said worm gear engaging said spur gear in driving relationship; and a pulley rotatably carried by said housing for receiving said cable and projecting said opposite end of said cable over the compressor for attachment to the compressor and lifting the compressor responsive to driving of said worm gear.

18. The lifting device of claim 17 comprising a pair of outriggers pivotally carried by said dolly for extension from said dolly and contacting a supporting surface and stabilizing said winch and the compressor.

19. The lifting device of claim 18 wherein said outriggers are each characterized by a top outrigger member pivotally and hingedly connected to said dolly, a bottom outrigger member extendible from said top outrigger member to a selected position and outrigger adjusting means engaging said top outrigger member and said bottom outrigger member for selectively securing said bottom outrigger member with respect to said top outrigger member in said selected position.

20. The lifting device of claim 19 wherein said telescoping mast is characterized by a mast base attached to said wheeled dolly, a mast extension adjustably extendible from said mast base and mast adjusting means engaging said mast base and said mast extension for selectively securing said mast extension in a selected position with respect to said mast base.
